(19) United States
(12) Patent Application Publication
(10) Pub. No.: US 2020/0402147 A1
(43) Pub. Date: Dec. 24, 2020

(54) E-COMMERCE SYSTEM, FLIKTAG

(71) Applicant: Joy Bixia LIN, Rockaway, NJ (US)

(72) Inventor: Joy Bixia LIN, Rockaway, NJ (US)

(21) Appl. No.: 16/918,470

(22) Filed: Jul. 1, 2020

Related U.S. Application Data
(60) Provisional application No. 62/863,079, filed on Jun. 18, 2019.

(51) Int. Cl. G06Q 30/06; G06Q 50/00; G06F 3/0488; G06F 3/16

(52) U.S. Cl. CPC G06Q 30/0643; G06F 3/167; G06F 3/0488; G06Q 50/01

(57) ABSTRACT

A digital system for mixing and matching items visually to create new combinations is disclosed. The system allows a registered user to spin a plurality of stacked carousels showing approximately how the items would look when worn by a person. The registered user may spin the carousels displayed on a display screen to select items to purchase or rent from various Item Sources, such as Vendors, Retailers, Brands, and other Registered Users. The registered user can then share outfits with other Registered Users. The Registered Users may also upload images and information of items from their own closets into their virtual closets to display, sell or rent to other Registered Users.

### CROSS-REFERENCE TO A RELATED APPLICATION

This application claims priority to U.S. Provisional Patent Application Ser. No. 62/863,079 filed Jun. 18, 2019 titled “A Digital System for Mixing and Matching Items Visually to Create New Combinations” by the same inventor as this application, as it were set forth in its entirely herein, to the extent that it does not conflict with the current application.

### BACKGROUND OF THE INVENTION

### 1. Field of the Invention

The current invention relates to a simple and enjoyable e-commerce system for displaying, matching, sharing, purchasing, renting-in or renting out items displayed on at several vertically stacked carousel displays.

### 2. Description of Related Prior Art

Currently, combining items online to make matching sets or outfits has been a challenge. Items appear on separate pages/websites owned by different brands, vendors or retailers (collectively “Merchants”). If there are combinations shown, they are typically from the same Merchant. Therefore, using conventional means, a user cannot display several items, each from different Merchants in a single display. This results in few options for a user which limits user's choices. For example, it's a challenge to coordinate a blouse, slacks, and shoes from different Merchants together in a single aggregate view to determine an overall visual effect.

Conventional websites and Apps may allow a user to share individual items, or web pages with other users or friends. However, they do not allow sharing of an outfit having several items which do not have to be from the same Merchant.

There may be sites or Apps which allow a user to buy items, sell items, rent-in and rent-out items. These are typically in different websites or Apps. Therefore, one cannot view an outfit use the same site/App to buy, sell, rent-in and rent-out items. Therefore, the user must learn how to navigate and operate several different websites/Apps to perform these functions. Each new website/App has a different method of logging in and its operation. This causes unnecessary frustration to the user.

There may be sites or Apps which allow a user to buy or even rent new items from the Merchants. However, these sites do not allow users to sell or rent their existing (used) items. These sites also do not allow a User to view their existing items on the same screen with other new or used items to view several items together as an outfit.

Most, if not all of the websites/Apps are designed to make sales quickly and are not targeted toward making the process enjoyable. Most are very ‘dry’ and not considered entertaining.

Many individuals enjoy the shopping experience and ‘mixing and matching’ different clothing items into an outfit.

Some of the User interfaces are difficult to use, do not allow for outfit views, and if so, do not allow for simple, intuitive interactive selections of various items.

Currently, there is a need for an entertaining and game-like system which allows one to simply and interactively view and select several new or used items together as an outfit, share these items with others, purchase, rent-in, sell or rent out items.

### BRIEF SUMMARY OF THE INVENTION

An e-commerce system is disclosed for buying, trading or renting items online which is entertaining to use having a plurality of remotely connected Item Sources, the Item Sources including databases of prestored Item Records, and are adapted to return search results when provided with search criteria.

A server, adapted to remotely communicate with the Item Sources to receive user input, creates search criteria from the user input, send search criteria to the Item Sources, receive search results from the Item Sources, separates the search results by into a plurality of display levels; and provides specified Item Records when requested.

It also includes a cloud storage coupled to the server for receiving information from the server, storing it and providing information back to the server, a plurality of carousel caches, each adapted to store a plurality of Item Records for a corresponding carousel display level;

The system also includes a UCD that has a display device for displaying a stacked carousel display having a carousel display for each of a plurality of levels, each carousel display level displaying an item image of an Item Record;

The UCD also employs an input device that receives user input to select a specific carousel display on a specific level and requesting that carousel display level and a specific rotation direction.

A UCD controller is coupled to the input device, the display device and the server through a communication device, that receives the user input and sends a next Item Record in a carousel cache for the specific carousel display level to be sent to the display device when the user input indicates a rotation in a first direction and sends a previous Item Record to be displayed on the specified carousel display level of the display device when the user input indicates a rotation in a second direction, thereby simulating rotation of an image carousel. Wherein the user, through the input device can select an item corresponding to an image displayed on a carousel display level and send information to purchase the item online.

The current invention may also be embodied as an entertaining e-commerce system having a plurality of Item Sources each having prestored information and images on a plurality of items in the form of Item Records

The Item Sources are adapted to receive search criteria and provide search results in the form of Item Records.

The system also includes a server coupled to the Item Sources through a network. The server is adapted to receive search criteria, provide the search criteria to at least one Item Source, receive the search results, being a plurality of Item Records from the at least one Item Source, sort the Item Records by their carousel display levels corresponding to a location on a user's body where the item will be worn and store the Item Records into a carousel cache corresponding to the carousel display level associated with each.

The system also includes a user's computing device (UCD) having;

an output device capable of displaying at least one stacked carousel having a plurality of carousel display levels vertically stacked upon each other, each with each vertical level pertaining to a section of a standing mannequin.

Each carousel display level displays images of items that are rotatable to the left and right, simulating a physical carousel.

The UCD also has an input device for receiving user input specifying a carousel level and a direction in which to spin the carousel display level.

The UCD is also adapted to receive user input identifying values of fields displayed on the output device for the user to view.

The UCD also has a UDC controller coupled to the input and output devices that is adapted to: receive user input indicating a carousel display level to be rotated and the direction to rotate, acquire a next image record from the current Item Record being displayed from the carousel cache associated with the indicated carousel display, if the rotation direction is to the right of the output device, and acquire a previous Item Record relative to the current Item Record when the indicated rotation is to the left of the output device and cause the output device to display an image from the acquired image record, thereby simulating rotation of a carousel.

The current invention may also be embodied as a method of e-commerce for items by executing the steps of employing a server controller to load a previously stored state of the system from a memory in the server controller, providing displays of images of items on a plurality of carousel displays each at a different level of a stacked carousel display on an output device to a Register User 1 (“RU 1”); employing an input device to interactively receive user input from RU 1 rotating at least one carousel display level in one of a left direction and a right direction; displaying on the output device a next image, relative to a currently displayed image, that was prestored in a carousel cache, when the user input indicates a rotation of an image on the carousel display level to a left of the output device; or displaying on the output device a previous image, relative to a currently displayed image, that was prestored in a carousel cache. when the user input indicates a rotation of an image on a carousel display level to the right of the output device.

The method of the current invention also includes the steps of displaying to a connected Registered Users at least one combination of items (an outfit) displayed on the carousel display levels of at least one Register User Device, when indicated by user input; receiving user input from the UCD allowing another connected Registered Users to view the current images on the carousel display levels of the UCD, when indicated by user input; employing the UCD and a server to perform an item search on at least one Item Source to results in a plurality of item records, some of which are stored by the server in the carousel caches; actuating the input device of the UCD to rotating the item so that it is displayed on one of the carousel display levels; employing the input device of the UCD to select a displayed item; and acquiring the selected item by one of purchasing, renting-in, or swapping another item for the selected item.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is a screenshot of one embodiment of a main screen of a user's computing device (“UCD”), such as that shown in FIGS. 17 and 19, showing a stacked carousel having three vertically stacked carousel display levels, also showing icons and images used to control the system.

FIG. 2 is an enlarged view of a top portion of the main screen shown in FIG. 1 illustrating one embodiment of several User Controls.

FIG. 3 is a screenshot of one embodiment of a main search screen of the UCD showing a subset of the search criterial that a user may select to perform a search according to the present invention.

FIG. 4 is a screenshot of one embodiment of a display of a ‘My Closet’ screen of the UCD used to manage the items that the Registered User owns and has uploaded to the system, according to the present invention.

FIG. 5 is a schematic illustration of one embodiment of the UCD showing two stacked carousel each having three carousel display levels that can be rotated to view images of items.

FIG. 6 is a screenshot of one embodiment of the UCD showing the stacked carousels, such as those of FIG. 1, superimposed upon a customer-generated avatar.

FIG. 7 is a screenshot of a ‘login’ screen according to one embodiment of the current invention.

FIG. 8 is a screenshot of a ‘measurement’ screen for inputting measurements of a person according to one embodiment of the current invention.

FIG. 9 is a screenshot of a ‘main’ screen according to one embodiment of the current invention.

FIG. 10 is a screenshot of a ‘search’ screen according to one embodiment of the current invention.

FIG. 11 is a screenshot of an ‘item detail’ screen according to one embodiment of the current invention.

FIG. 12 is a screenshot of a ‘seller account’ screen for inputting information relating to an item to be sold, according to one embodiment of the current invention.

FIG. 13 is a screenshot of one embodiment of a ‘second-hand’ screen for selling or renting-out items according to one embodiment of the current invention.

FIG. 14 is a screenshot of a ‘My Closet’ screen for selling or renting-out items owned by the registered user according to one embodiment of the current invention.

FIG. 15 is a screenshot of a ‘My Closet—my outfits’ screen for selling or renting-out items according to one embodiment of the current invention.

FIG. 16 is a screenshot of a ‘shopping cart’ screen for buying or renting-in items according to one embodiment of the current invention.

FIG. 17 is a schematic illustration of a simple and entertaining system for purchasing, selling, renting-in items and renting-out items according to the present invention.

FIG. 18 is a more detailed schematic illustration of the server of FIG. 17.

FIG. 19 is a more detailed schematic illustration of the UCD of FIG. 17.

FIG. 20 and FIG. 21 together combine to result in a flowchart which illustrates the functioning of the current system.

FIG. 22 is a more detailed illustration of the steps to update user search parameters of FIG. 20.

FIG. 23 is a more detailed illustration of the steps to perform the search of FIG. 20.

FIG. 24 is a more detailed illustration of the steps to toggle viewing privileges of FIG. 20.

FIG. 25 is a more detailed illustration of the steps to toggle display control privileges of FIG. 20.

FIG. 26 is a more detailed illustration of the steps to perform the ‘carousel rotate’ routine of FIG. 20.

FIG. 27 is a more detailed illustration of the steps to perform ‘remote carousel rotate’ routine of FIG. 20.

FIG. 28 is a more detailed illustration of the steps to perform the ‘buy’ routine of FIG. 21.

FIG. 29 is a more detailed illustration of the steps to perform the ‘rent-in’ routine of FIG. 21.

FIG. 30 is a more detailed illustration of the steps to perform the ‘sell’ routine of FIG. 21.

FIG. 31 is a more detailed illustration of the steps to perform the ‘rent-out’ routine of FIG. 21.

FIG. 32 is a more detailed illustration of the steps to perform the ‘shopping cart’ routine of FIG. 21.

FIG. 33 is a more detailed illustration of the steps to perform the ‘sweepstakes ‘routine of FIG. 21.

### DETAILED DESCRIPTION OF THE PREFERRED

### Embodiments of the Invention

The current embodiment of the invention (the “system”) allows shoppers to experiment with combinations that include items they own and items they are considering for purchase. Rather than the frustration of shopping without visual context, they experience the joy of seeing how new purchases work when combined with existing items or other new purchases.

The system allows shoppers to mix and match owned items with acquisition prospects in endless combinations. The result is that consumers make well informed decisions and take delight in the shopping process.

Previous to the invention, combining items online to make a matching set has been a challenge that is spread across multiple views, or was displayed in an intuitive, interactive way that imitates how outfits appear when worn by a person. Items appear on separate pages or in combinations defined by Merchants, with few options; this limits user choice. For example, it's a challenge to coordinate a blouse, slacks, and shoes because the items are not presented visually within one aggregate view resembling an outfit on a person.

The invention claimed here solves this problem. Shoppers can see related items stacked in multiple rows, one stacked on top of another. Users can move the rows horizontally, allowing them to visually manipulate items until they have pleasing matches in vertical alignment. Each row contains an endless stream of similar products, allowing users the freedom to freely express themselves by the combinations they create. The same method of matching may be employed in columns arranged side by side.

This invention is an improvement on what currently exists. The invention provides for the visual aggregation of multiple items to create unique combinations visualized in one view. For apparel in particular, the ability to create endless combinations of tops, bottoms, shoes, hats and accessories and other items fills a void.

In other online shopping systems, user choices are confined to single items or Merchant-created combinations with few options. Online shopping systems don't consider acquiring new items in the context of previously acquired items, leading to buyer frustration and purchase regret.

In order to address the shortcomings of the prior, known e-commerce systems, reference is made now to Figures described below, where there is illustrated a novel e-commerce system viewing, sharing, purchasing, renting-in, selling or renting out items in a simple and entertaining manner.

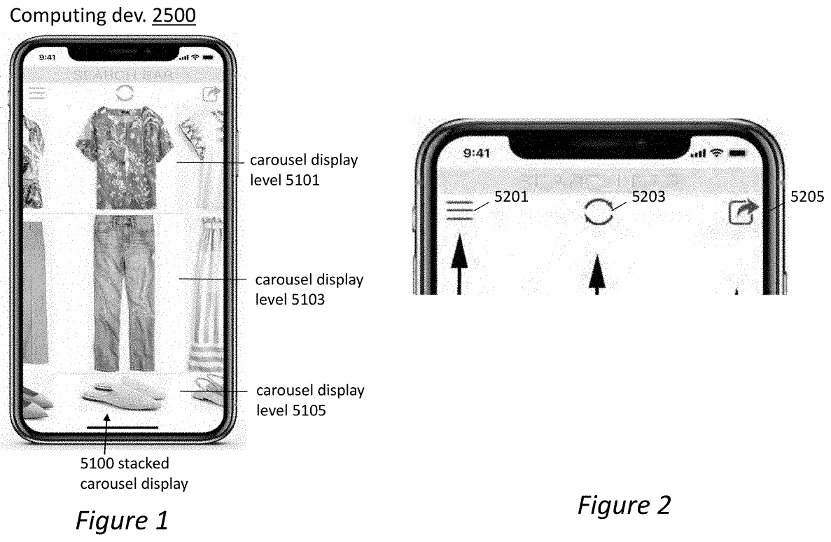

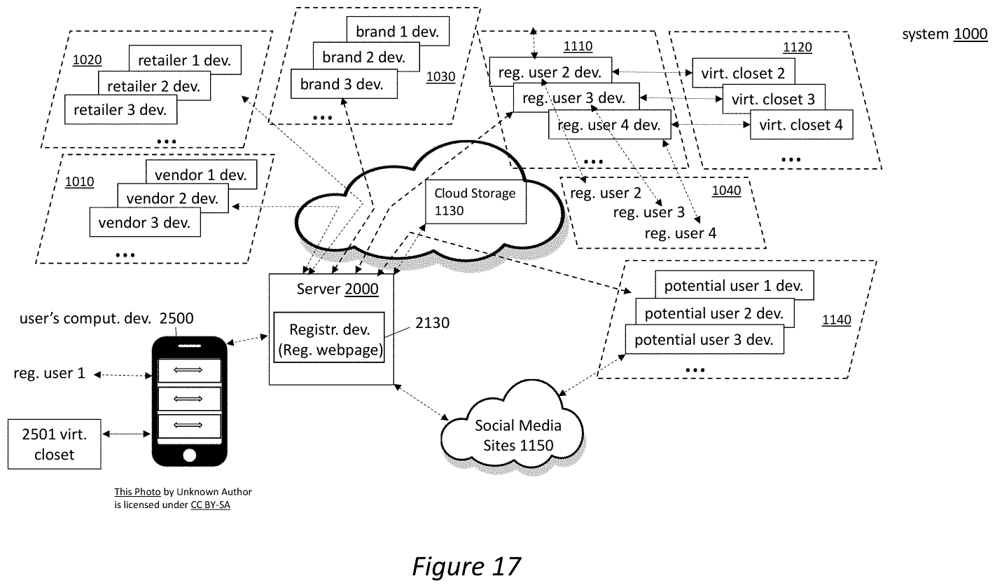

The system will be explained in connection FIGS. 1-5 for screen images. The system 1000 will be explained in connection with FIGS. 17, 18 and 19 for systems and hardware descriptions.

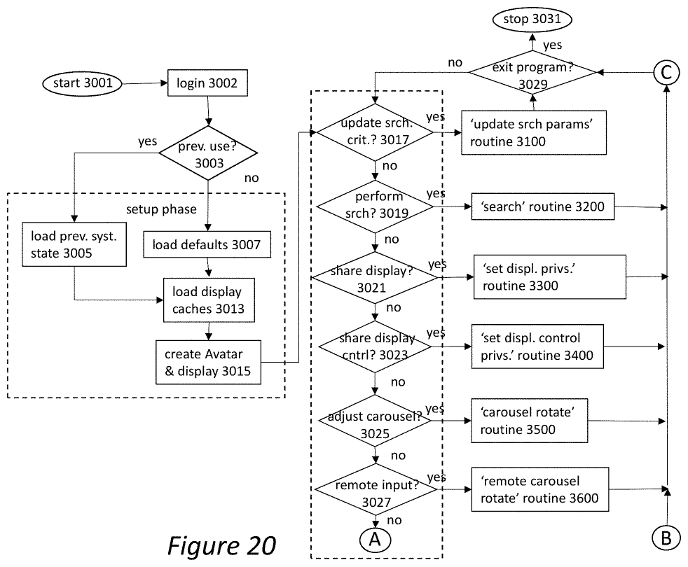

The system will also be explained in connection with FIGS. 1-5 for screen images, FIGS. 17-19 for the hardware elements of the system and FIGS. 20-33 for the functionality (flowchart).

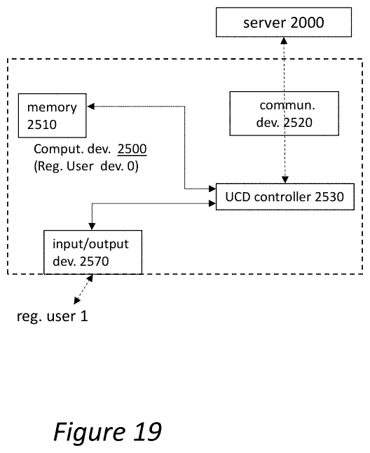

A single stacked carousel display 5100 having three carousel display levels 5101, 5103, 5105 is shown in FIG. 1 and is a screenshot of input/output (“I/O”) device 2570 of UCD 2500 in FIG. 19. In this embodiment, I/O device (2570 of FIG. 19) is a touch sensitive screen and UCD (2500 of FIG. 19) is a mobile device. This system will be described from the perspective of user that has previously registered with the system, referred to as “registered user 1” or (“RU 1”). RU 1 operates UCD 2500 which interfaces with the rest of the system. It should be understood that any of the other registered users (registered user 2, registered user 3, registered user 4) collectively, “Registered Users 1040” may interact through their respective Registered User Devices 1110 in place of RU 1 and UCD 2500 to operate the system.

This embodiment employs a touchscreen; however, it may also be implemented with a variety of conventional input and output devices in various different embodiments. Images and text are provided to RU 1 through the touchscreen in this embodiment. However, various other conventional display means may be employed and still remain within the ‘spirit of this invention’.

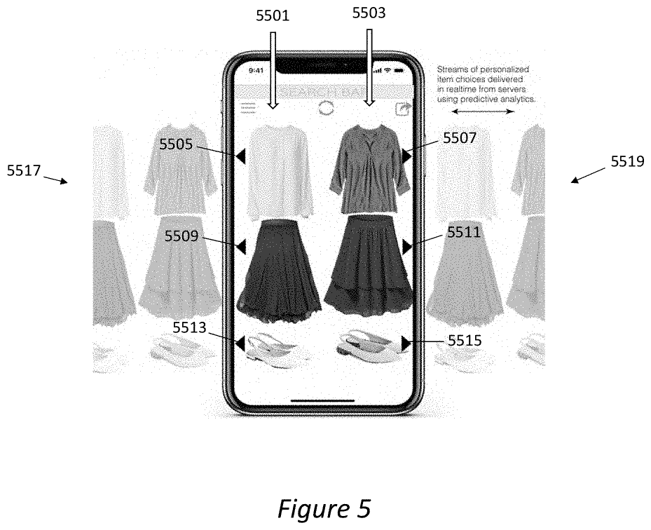

Touching and ‘dragging’ the image on the touch screen, (or alternatively, actuating buttons (5505, 5507, 5509, 5511, 5513, 5515 shown in FIG. 5) RU 1 can slide each row, or carousel display level 5101, 5103, 5105, of the stacked carousel display 5100 independently. Additional images of items are rotated into view from the right automatically as RU 1 slides a displayed image to the left. As RU 1 slides a displayed image to the right, additional image is rotated into view from the left of the display.

For the remainder of this disclosure, any references to an input device may refer to conventional touchscreens such as that on conventional cellular telephones, a mouse, trackball, touchpad and similar known computer input devices that can receive input from a user, referred to as “user input”.

An output device will refer to any known computer, or smartphone output devices which can display images, text or video that can display output to a user.

An input/output (“I/O”) device will refer to any device which can both receive input from a user and provide output to a user.

Any conventional means for a user to input information or choices to the system 1000 may be employed in various embodiments as a ‘User Control’. These may be physical buttons, knobs, pointing devices and displayed images, computer mice, touchpads with icons, text, fields or images in which a user may see prompts and input information. These also may include images, displays, fields, text, lists, etc. for prompts. Collectively, they all can be considered User Controls.

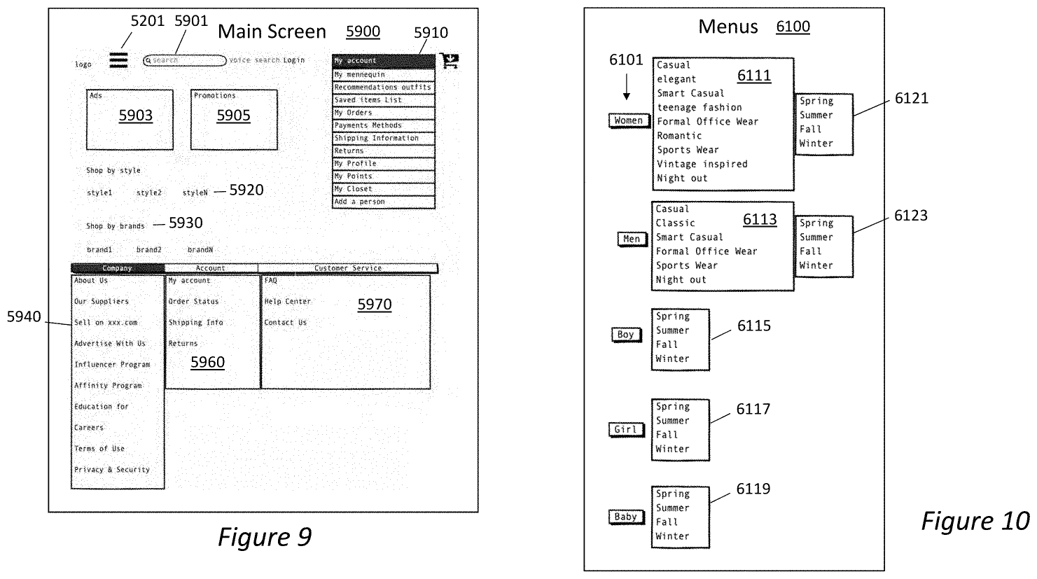

In FIG. 2, several buttons or icons are always visible and active (persistent) on the display of I/O device 2570 of user computing device (“UCD”) 2500 shown of FIG. 19. Examples of a main menu icon 5201, randomizing icon 5203 and another icon 5205 that may actuate another executable routine in UCD 2500 are shown at the top of FIG. 2. These are accessible at any time. Main menu icon 5201 brings up a main screen, such as the screen shown in FIG. 9.

Randomizer icon 5203 allows the system to rotate the carousels a random number of images spinning the carousels like a slot machine. This is intended to make use of the system entertaining and fun to use. This causes a ‘spin’ of the carousels that ends with randomly selected items shown in each of the carousels.

There is a button 5205 that when selected will toggle to allow/not allow sharing an outfit (items on carousel 5201, carousel 5202 and carousel 5203) with another RU 1110 of FIG. 17.

The system is set up not only to share outfits, but also to allow text and/or voice communications between users of the system. This way users can share outfits, text each other, chat, or have voice conversations. (Chat and voice communication buttons may also be added.)

Also, an icon 5207 may be employed which, when selected by RU 1, jumps to a screen which will allow RU 1 to give some or all screen control to another Registered User Device 1100. This allows that registered user to spin carousels 5101, 5103, 5105 on UCD 2500 from a remote location.

Also, another icon 5209 may then be selected which causes the system to execute a different routine.

FIG. 2 is provided as an example, but any number, type or style of User Controls may be displayed on the output device (display screen) and related user input is received on various types of input devices of the UCD in various other embodiments.

As shown in FIG. 17, registered user 2 device, registered user 3 device, registered user 4 device, are collectively referred to as “Registered User Devices 1100”. Each Registered user device is operated by its corresponding registered user 2, registered user 3, registered user 4 (collectively, “Registered Users 1040”).

FIG. 17 shows UCD 2500 which connects to a server 2000. The server 2000 is also connected through a network, such as the Internet, to devices of vendors such as vendor 1 device, vendor 2 device, and vendor 3 device, collectively referred to as “Vendor devices” 1010. These represent e-commerce systems from various vendors which sell or rent items, such as clothing items.

The server 2000 is also connected through a network, such as the Internet, to devices of retailers such as retailer 1 device, retailer 2 device, and retailer 3 device, collectively referred to as “Retailer devices” 1020. These represent e-commerce systems from various retailers which sell or rent items, such as clothing items.

Similarly, server 2000 is also connected through a network, such as the Internet, to devices of brands such as brand 1 device, brand 2 device, and brand 3 device, collectively referred to as “Brand devices” 1030. These represent e-commerce systems from various brands which sell or rent items, such as clothing items.

Server 2000 is also connected through a network, such as the Internet, to the Registered User Devices 1110. These Registered User Devices 1110 have previously registered with the system.

Server 2000 is also connected through a network, such as the Internet, to devices similar to UCD 2500, of users who have not yet registered to use the system. These are referred to as potential user 1 device, potential user 2 device, potential user 3 device, collectively referred to as “Potential User devices 1140”. These may connect to Social Media Sites 1150.

Server 2000 has the ability to store information in cloud storage 1130 and retrieve it from cloud storage 1130. Cloud storage 1130 may include any conventional remote servers which are capable of storing and retrieving data.

Server 2000 is also capable of storing information on conventional social media websites, referred to as Social media Sites 1050.

RU 1 interacts with UCD 2500 to accept user input, receive audio input, display still images and/or video output, as well as providing audio output. In at least one embodiment, UCD 2500 comprises a smart phone. UCD 2500 includes one or more I/O devices 2570 of FIG. 19. These may include a touch sensitive screen or known conventional input and output devices. RU 1 then provides input through I/O device 2570 to select search criteria to search at least one of the Vendor Devices 1110, Retailer Devices 1020, Brand Devices 1030 and Registered User Devices 1110 of FIG. 17 (collectively, the “Item Sources”) and receive Search Results having a plurality of items which match the Search Criteria. This may be done by the RU 1 actuating a button, or other input symbol on the screen. (Many different types of conventional symbols, buttons, text boxes, etc. may be used.)

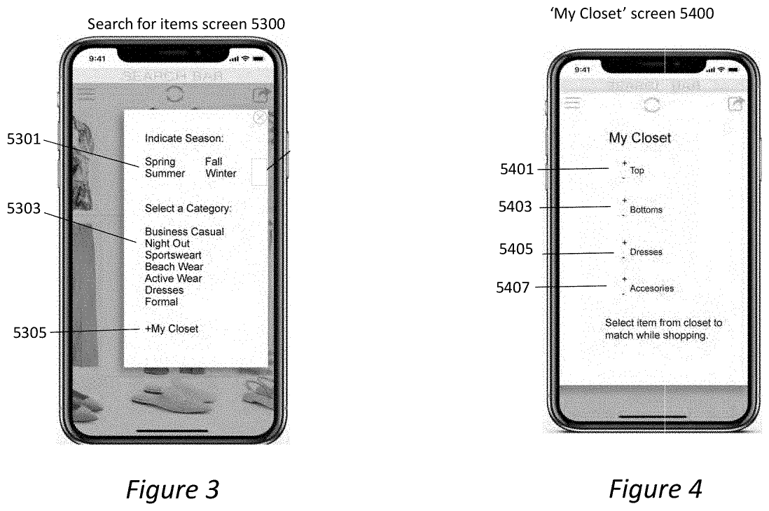

Actuating a User Control will cause the system to run a routine which displays an input screen such as that shown in FIG. 3 or 10. As shown in FIG. 3, the RU 1 may select one of the ‘season’ text displays 5301 to view items related to that season.

The RU 1 then selects a category 5303 of the item. There also may be other buttons/text/selections or free form fields in which the RU 1 may identify Search Criteria.

The Search Criteria are used to search at least one Item Source identified by the RU 1 to receive Search Results which are displayed on UCD 2500 to RU 1.

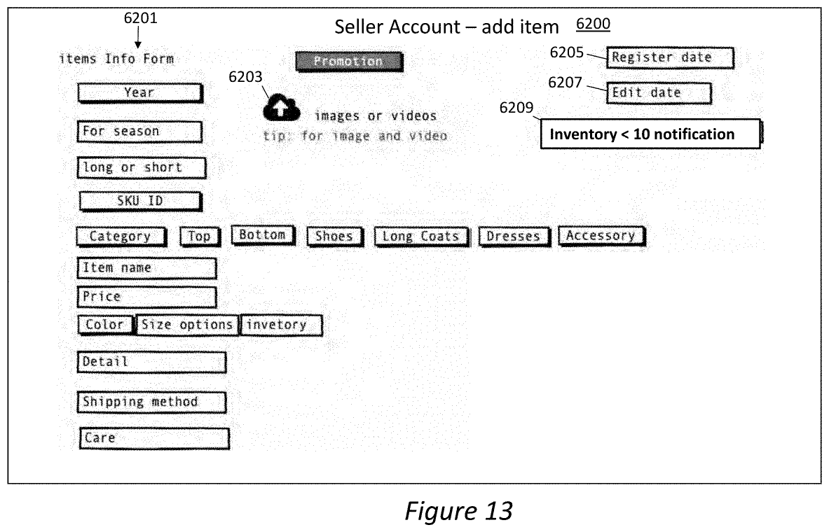

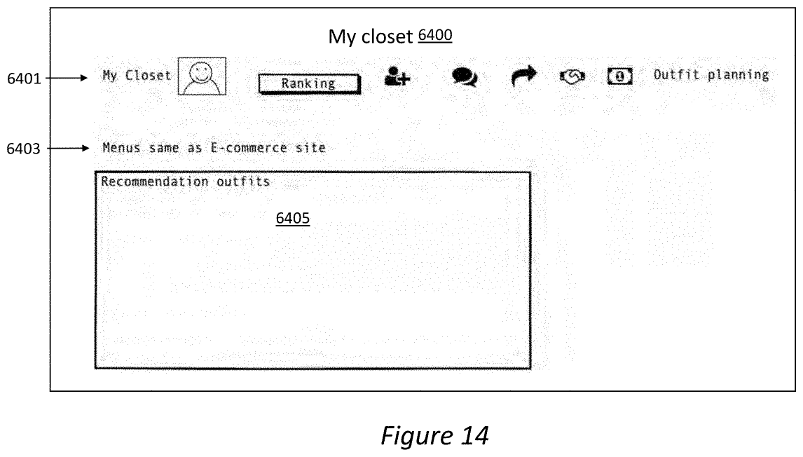

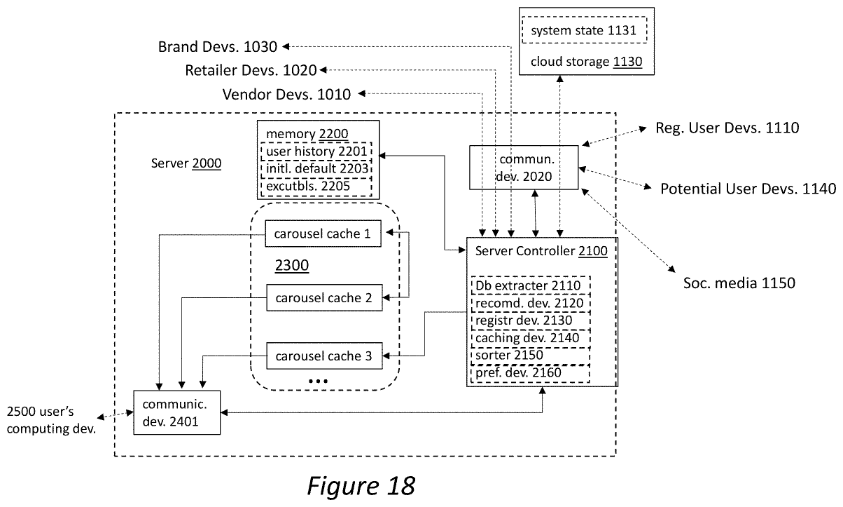

In the embodiment of FIG. 3, there is also a text display “+My Closet” 5305 which jumps the user to a “My Closet” screen 6400 of FIG. 14 when selected. This allows a registered user to upload images, videos of items and enter specific information for clothes, hats, shoes and accessories (collectively referred to as “items”). The specific information may include an identification of the manufacturer, brand, year, and similar information (collectively an “Item Record”) for fields indicated in FIG. 13. The Item Records are stored in Virtual Closets 2501 and 1120 of RU 1 and Registered User 1040, respectively. The Item Records may also be stored in a memory 2200 of server 2000 or cloud storage 1130 as shown in FIG. 18. The storage for each Registered User Device 1100 is referred to as the “Virtual Closet” of that user. Other embodiments may use additional or different fields and accept different information that he/she owns into the system to match outfits, rent or sell the items.

In FIG. 14, there are User Controls in the form of icons 6401 across the top which, when selected, activate various subroutines.

The screen including text and input buttons of FIG. 10 should be displayed in the area marked 6403 of FIG. 14. The User Controls of Area 6403 should also have similar functionality to those of FIG. 10.

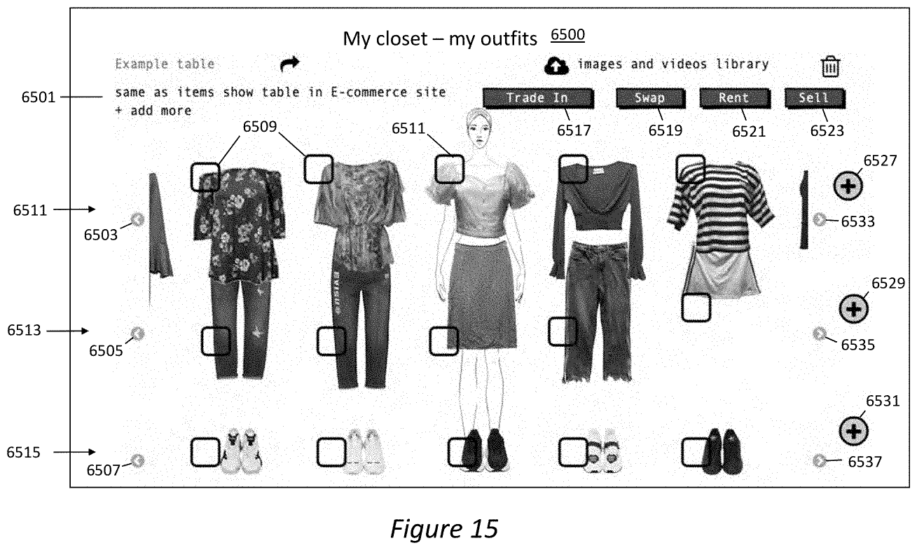

This embodiment also includes a selectable button ‘Recommendation outfits’ 6405 button, that when selected jumps the user to the ‘My Closet—My Outfits’ screen 6500 shown in FIG. 15.

FIG. 15 ‘My closet—my outfits’ screen 6500 of this embodiment shows five stacked carousels, each having three levels 6511, 6513, 6515. These display items owned by the RU 1 There are buttons 6503, 6505 and 6507 which move each level to the left and three other buttons 6529, 6531, and 6533 which move each level to the right. The RU 1 can then manipulate the carousels to line up the proper top, skirt/pants and shoes to be placed on the avatar 6511.

There also may be a User Control which, when actuated, allows RU 1 to share the center stacked carousel and its currently displayed images showing an outfit that RU 1 would like to share. RU 1 can then select which Registered User Devices 1100 or which Social Media Sites to share this outfit. These are then provided with a still image of the stacked carousel. Alternatively, RU 1 can allow a ‘live feed’ showing at least a portion of the output device of UCD 2500.

There are also checkboxes 6509 on all items so that one or more items may be easily selected.

There are “+” icons 6527, 6529 and 6531 for levels 6511, 6513 and 6515, respectively, which allow the RU 1 to add another item to a level.

FIG. 4 shows an alternative embodiment for organizing the virtual closet of an RU 1. Here RU 1 may click on “Top” and jump to a screen which shows an inventory of tops that the RU 1 owns. They may be displayed in a fashion similar to that shown in FIG. 15. Similarly, the RU 1 may click on button 5403 to view “Bottoms” in the virtual closet. By clicking on the button 5405 labeled “Dresses”, the dresses in the virtual closet of RU 1 are displayed. By clicking on the button 5407 labeled “Accessories”, the accessories in the virtual closet of RU 1 are displayed.

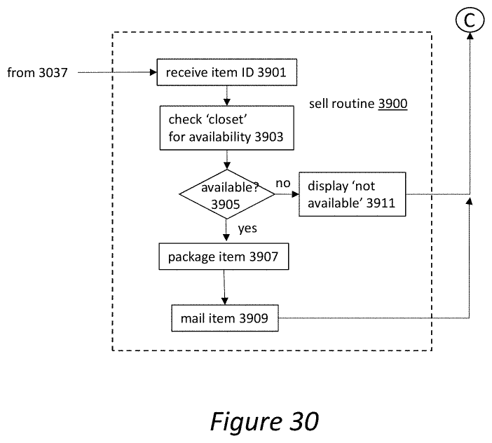

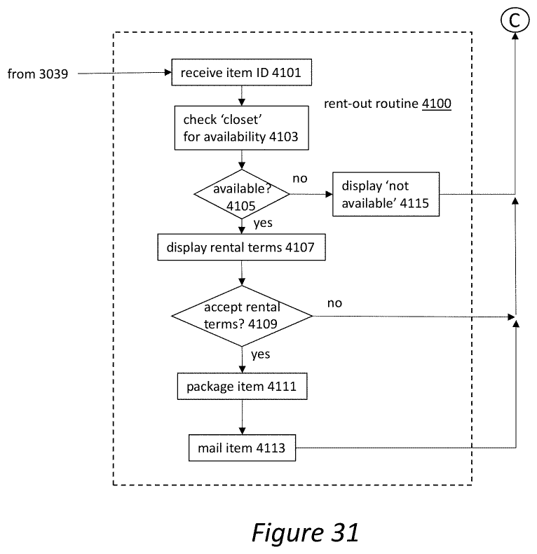

The selected items may then be traded in if button 6517 is selected or swapped if button 6519 is selected. The selected items may be rented out if button 6521 is selected, sold if button 6523 is selected or deleted if icon 6525 is selected. If sold, then routine 3900 of FIG. 30 is performed. If rented out, then routine 4100 of FIG. 31 is performed.

UCD 2500 of FIG. 17 can wirelessly connect with server 2000 to provide his input or receive output of server 2000.

Server 2000 can provide requests to Vendor Devices 1010, Retailer Devices 1020 and Brand Devices 1030 to provide information and images of specified items that the Merchants have for sale or for rent. These may be database requests with criteria defined for various fields in the databases of the Vendors, Retailers and Brands.

The results of the searches are stored in either or both the cloud storage 1130 and server 2000.

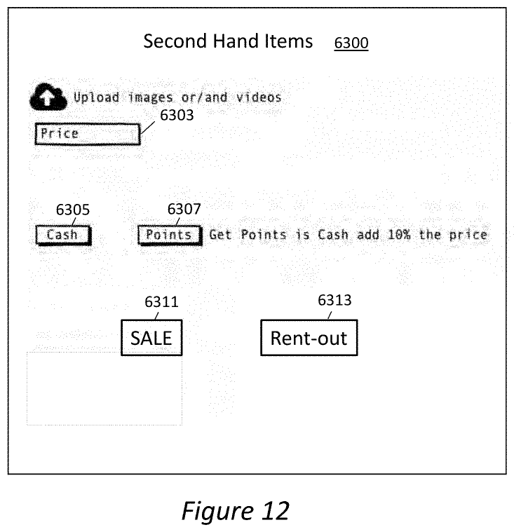

In at least one embodiment of this invention, Registered Users 1110 may offer to sell or rent items that they currently own. The Registered User can take pictures of an item and store them in his/her ‘Virtual Closet’ 1120, provide a description of the item and set a price to sell the item which is uploaded to cloud storage 1130. (Alternatively, this information may be stored on the Registered User's device 1110.) This information may be entered through the use of screens such as those shown in FIGS. 12-15.

In FIG. 12, items owned by RU 1 can be uploaded into a Virtual Closet 2501 by clicking on icon 6301. This may open another dialog page.

RU 1 can take pictures of an item he/she owns and add it to his/her Virtual Closet 2501, provide a description of the item and set a price to rent the item. This information is uploaded to cloud storage 1130 of FIG. 17. (Alternatively, this information may be stored on the Registered User's device 1110.)

The RU 1 types in a price to sell the item in field 6303 of FIG. 12.

Optionally, the RU 1 can set the price based upon the points accumulated by a buyer. The number of points is calculated and displayed in field 6307.

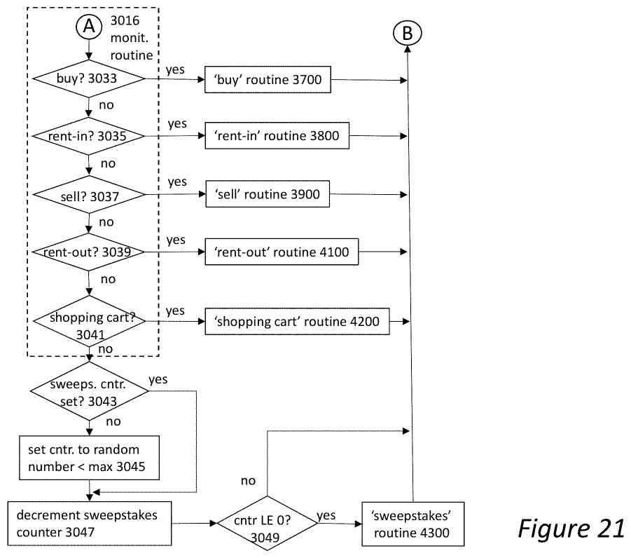

RU 1 can then select button 6311 indicating that the item is for sale and routine 3800 of FIG. 21 executes.

RU 1 can select button 6313 indicating that the item is intended to be rented out and starts a ‘rent-out’ routine 4100. This performs the functions of the ‘sell’ routine 3900 and additionally sets up rules regarding the use and return of items.

In FIG. 13, item information for items intended to be sold are entered into the fields 6201. An icon or button 6203 or other User Control can be activated to view previously uploaded images or videos of the item. The register date can be added to field 6205, the edit date is displayed in field 6207 and the number in inventory is displayed in field 6209.

RU 1 can actuate a User Control on UCD 2500 causing server 2000 to send at least a portion of images displayed on the I/O device 2570 of UCD 2500 to authorized Registered Users 1110. This allows Registered Users 1110 who are authorized, to simultaneously view the screen of UCD 2500. This is done in part by executing ‘set display privileges’ routine 3300 of FIG. 20.

RU 1 can also make selections on UCD 2500 which are provided to server 2000 which prevent Registered Users 1110 from viewing the display of UCD 2500 in ‘set display privileges’ routine 3300 of FIG. 20.

RU 1 can make selections on UCD 2500 which are provided to server 2000 which allow another Registered User 1110 to control at least a portion of the display of UCD 2500 in ‘set display control privileges’ routine 3400 of FIG. 20.

RU 1 can also make selections on UCD 2500 which are provided to server 2000 which prevent Registered Users 1110 from viewing or controlling the display of UCD 2500 ‘set display control privileges’ routine 3400 of FIG. 20.

The structure and function of the current invention is now described in greater detail in connection with FIGS. 17, 18 and 20.

Use of the Invention:

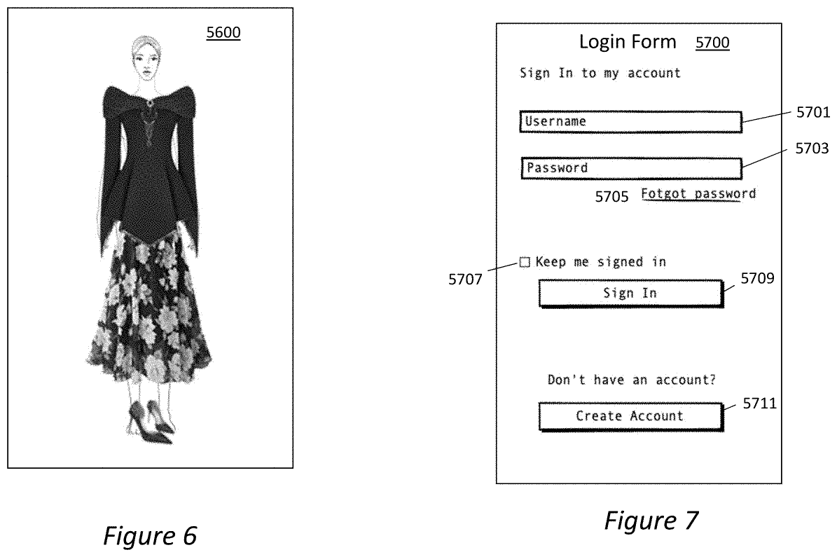

The images of item records of the Search Results are presented as shown in a carousel display such as that of FIG. 1, 5 or 6. (FIG. 6 is a modified FIG. 1 which now includes the items as worn by a mannequin, or optionally an Avatar created by the RU 1.) RU 1 can slide rows (carousel display levels) horizontally to create alternative combinations of item images referred to as outfits. FIG. 5 shows the use of left buttons 5505, 5509 and 5513 causing the items in the carousels to rotate to the left whereby items of stacked carousel 5501 are rotated out of screen view and items of stacked carousel 5503 replace them.

Also, the grayed-out image 5519 represents the next items to enter from the right. These items are from the Search Results that have been preloaded into the carousel caches 2300 of FIG. 18.

Similarly, the embodiment also shows right buttons 5507, 5511 and 5515 which cause the grayed-out images 5517 representing items that may be rotated into the screen from the left.

Therefore, almost endless combinations of items may be easily viewed by using this and other embodiments of the current invention.

++++++++++++++++++++++++++++

The process of an embodiment of the current invention starts at step 3001 of FIG. 20.

In step 3002, the RU 1 logs into the system. This may be done through the input to a screen on UCD 2500 such as login screen 5700 shown in FIG. 7. The RU 1 types in a username into field 5701, a password into field 5703, and clicks the “keep me signed in” checkbox 5707. The user then clicks the “sign in” button 5709.

If the username and password are not accepted, the RU 1 then can click on “Forgot password” and receive a password to a known e-mail address or phone.

Alternatively, if the user is not a Registered user, (does not have an account) then the user may click on “Create Account” button 5711 to register with the system 1000.

In step 3003, of FIG. 20, server controller 2100 checks user history data 2201 for the RU 1 in memory 2201. If past user history is found (“yes”) for RU 1, server controller 2100 connects through communication device 2020 to cloud storage 1130 and loads the system state 1131 for RU 1. The system state includes all of the variables and their values which defines the state of system 1000 as of its last use. The results of the last search performed by Database extractor 2110 are also stored as part of the system state 1131 in cloud storage 1130.

If no previous use was found for RU 1 (“no”), then in step 307 server controller 2100 acquires predetermined initial defaults 2203 from memory 2200 and loads them into the system as an initial system state.

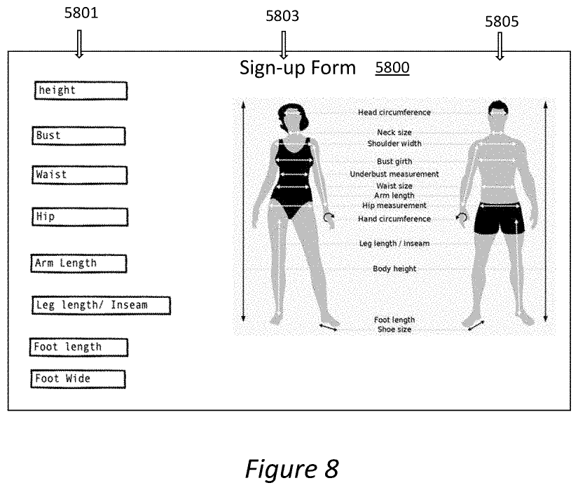

Also, a Sign-up form 5800 of FIG. 8 is displayed on UCD 2500 prompting the RU 1 to input measurements to find items. Information is provided by RU 1 to fields 5801 indicating measurements. There also are images of a woman, 5803 and a man 5805 showing how to make these measurements. These measurements may be saved with a date last modified. There may be several different measurement files for the RU 1, but the most recent will be used, unless overridden by the RU 1. (These past measurement files will indicate changes in shape of the RU 1 over time.)

It is also possible to have several different measurements filed, each for a different person for whom RU 1 is buying items.

A portion of the system state has items from the Vendor devices 1010, Retailer Devices 1020 or Brand Devices 1030 or Registered User Devices 1110 and their associated item records. In step 3013, cache device 2140 loads carousel cache 1 with images and associated information of items from the Item Sources which pertain to this carousel 5101. Cache device 2140 also loads carousel caches 2 and 3 with images and associated information of items from the Item Sources which pertain to carousels 5102 and 5103 respectively.

Carousels 5101, 5102 and 5103 are stacked vertically and display items in their respective vertical levels. For example, in FIG. 1 carousel 5101 is at the top and displays blouses or shirts. Carousel 5103 is below carousel 5101 and displays pants, shorts or skirts. Carousel 5105 is at the bottom which displays shoes.

The reason they're called carousels are because they imitate rotation of a physical carousel. The user can touch one of the carousels and drag it to the left causing another image to rotate in from the right as the current image is rotating out of view to the left.

Similarly, if the user drags the current image to the right a new image rotates in from the left as the current image is rotating out of view to the right.

Server 2000 has a plurality of carousel caches such as carousel cache 1, carousel cache 2 and carousel cache 3, in this embodiment. Each pertains to a portion of the display of computer UCD 2500, as shown on FIG. 1. Therefore, carousel cache 1 pertains to a top portion of the display of FIG. 1 labeled as carousel 5101. Carousel cache 2 pertains to carousel 5103 of the display in FIG. 1, and carousel cache 3 pertains to carousel 5105 of FIG. 1. Since the display of UCD 2500 of FIG. 1 is a touch sensitive screen, as the User touches and ‘drags’ the image on carousel 5101 to the left, another image is rotating in from the right.

A caching device 2140 in the server controller 2100 takes a portion of the stored search results, determines which are to be loaded into which caches, and loads the caches.

Caching device 2140 may interact with a sorting device 2150 which has preloaded logic that can determine which items are associated with which carousel caches 2300. The carousel 5101, carousel 5103 and carousel 5105 combine together to create a single composite image of a mannequin, Avatar or person wearing an outfit. In this embodiment, it is shown as shoes and clothing in proper position to imitate a person standing and wearing them, as shown in FIG. 1. Therefore, items loaded in carousel cache 1 are intended to be displayed on carousel 5101. These are tops, such as shirts, blouses and jackets.

Carousel cache 2 is loaded with items which are pants, shorts, skirts, etc. which are worn on a person's lower portions.

Carousel cache 3 is loaded with footwear, such as shoes, sneakers, sandals.

In step 3015 of FIG. 20, optionally, images can be displayed on carousel display levels overlaying an image of a standing person or mannequin. This mannequin may be selected and customized by RU 1 to create an “Avatar” which can be used in place of the image of a mannequin.

Steps 3003 to 3015 may be referred to as a setup phase 3010 which gets the system 1000 ready for use.

At any time, User Controls displayed on the screen can be selected to cause different screens to be displayed. For example, if the main menu icon 5201 of FIGS. 1 and 2 was selected, it would display the Main Screen 5900 shown in FIG. 9. In this case, a search area 5901 will be displayed which would allow one to search the current site. Field 5905 will display “Promotions”. Field 5910 will display a number of fields ranging from adjusting the ‘mannequin’ to ‘Adding a person’.

A selectable text field 5920 allows RU 1 to select a style to search, and selectable field 5930 allows RU 1 to select a brand to shop.

Field 5940 allows the RU 1 to review and change parameters relating to the company.

Field 5960 allows the RU 1 to review and adjust parameters relating to his/her account.

Field 5970 has buttons to jump to screens which have customer service information and tools.

The following steps are described in connection with FIGS. 17-20.

Steps 3017 through 3041 represent a ‘monitor’ routine 3016. This routine, preferably stored in memory 2510, is loaded and run by controller 2530. It checks to see if a button or other User Control was selected for a specific routine to run.

In step 3017 UCD controller 2530 of UCD 2500 determines if the RU 1 has interacted with an I/O device 2570 to indicate that search criteria should be modified. If so, (“yes”), then the ‘update search parameters’ routine 3100 is loaded from memory 2510 and executed. This routine allows RU 1 to review, change, update, delete search criteria.

If not (“no”) in step 3017, then in step 3019 the ‘monitor’ routine 3016 checks to see if RU 1 has indicated that Database extractor 2110 of the server 2000 is to perform a ‘search’ routine 3200.

If (“yes”) in step 3019, then Database extractor 2110 performs a ‘search’ routine 3200 using the current search criteria.

If (“no”) in step 3019, then in step 3021 it is determined if other Registered User Devices 1100 should be able to view the display on screen of UCD 2500 of RU 1.

If (“yes”) in step 3021, then UCD controller 2530 loads ‘set display control privileges’ routine 3300 from memory 2510 and runs it.

If (“no”) in step 3021, then in step 3023 it is determined if a Registered User device 1110 should be able to control the carousels and other controls of UCD 2500. This would cause UCD 2500 to be responsive to the commands sent from a remote Registered User device 1110. This will involve running set display control privileges' routine 3400.

UCD 2500 will also be able to cancel the control provided to the remote Registered User device 1110.

If (“no”) in step 3023, then in step 3025 it is determined if RU 1 has provided input to the I/O device 2570 of UCD 2500 to spin a carousel. If (“yes”) in step 3025, then ‘carousel rotate’ routine 3500 is loaded from memory 2510 and is run by controller 2530.

If (“no”) in step 3025, then in step 3027 it is determined if remote input was received from a RU 1110 by server controller 2100 through communications device 2020 to spin a carousel. If (“yes”) in step 3027, and if display control privilege is set “on” for at least one Registered User 1110, then ‘remote carousel rotate’ routine 3600 is loaded from memory 2510 and is run by controller 2530. This allows one Remote User 1110 to have remote control of the spinning of the carousels display levels displayed on UCD 2500.

The functioning and structure of the current invention will now be described in connection with FIGS. 17, 18, 19 and 21.

If (“no”) in step 3027, then processing continues to step 3033 in FIG. 21. It is determined by server controller 2100 of UCD 2500 if RU 1 has interacted through I/O device 2570 that he/she would like to buy an item. If so, (“yes”), then controller 2520 loads the ‘buy’ routine from memory 2510 and executes it to buy an item.

In an alternative embodiment, RU 1 can ‘swap’ (give in return for some other item of value) an item RU 1 owns to get another item from another Registered User 1040. This will follow a similar procedure to that of buying an item, except that it involves sending an item of RU 1 to the Registered User 1040, similar to that of the ‘rent-out’ routine 4100 of FIG. 31.

If this is not a permanent transfer of ownership, RU 1 and Registered User 1040 may propose and agree to use and return conditions, also similar to those of the ‘rent-out’ routine 4100.

If (“no”) in step 3033, it is determined by server controller 2100 of UCD 2500 in step 3035 if RU 1 would like to rent an item from another Item Source (‘rent-in’ an item”). If so, (“yes”), then the ‘rent-in’ routine 3800 is loaded from memory 2510 and executed.

If (“no”) in step 3035, then in step 3037 it is determined by server controller 2100 if RU 1 would like to sell an item from his/her virtual closet 2501. If (“yes”) in step 3037, then ‘sell’ routine 3900 is loaded from memory 2510 and is run by controller 2530. This allows RU 1 to upload images and information of items in his/her closet 2501 to sell using UCD 2500, send the images/information to server 2000 and then to cloud storage 1130 to be available for other Registered Users 1110 to view and possibly buy.

If (“no”) in step 3037, then in step 3039 it is determined by server controller 2100 if RU 1 would like to rent-out an item from his/her virtual closet 2501. If (“yes”) in step 3039, then ‘rent-out’ routine 4100 is loaded from memory 2510 and is run by controller 2530. This allows RU 1 to upload images and information of items in his/her virtual closet 2501 to rent out using UCD 2500, send the images/information as an Item Record to server 2000 and then to cloud storage 1130 to be available for other Registered Users 1110 to view and possibly rent.

If (“no”) in step 3039, then in step 3041 it is determined by server controller 2100 if RU 1 would like to purchase or rent in items in his/her shopping cart. If (“yes”) in step 3041, then ‘shopping cart’ routine 4100 is loaded from memory 2510 and is run by controller 2530.

If (“no”) in step 3041, then in step 3043 it is determined by server controller 2100 if a sweepstakes counter has already been set. If (“no”) in step 3045 the sweepstakes counter is set to a random number less than a pre-determined maximum. This predetermined maximum can be adjusted.

If (“yes”) in step 3043, then processing continues at step 3047. In step 3047 the sweepstakes counter is decremented.

It is then determined in step 3049 if the sweepstakes counter is less than or equal to 0. If so, (“yes”), then the ‘sweepstakes’ routine 4300 is loaded from memory 2510 and executed by controller 2530.

After any of the routines 3100 through 4300 are executed, processing continues at step 3029. At step 3029 it is determined if the RU 1 has indicated that he/she would like to exit this program. If so (“yes”), then the processing stops at step 3031.

If it is (“no”) in step 3029, the processing continues at step 3017.

+++++++++++++++++++++++++++++++++++++++++++++

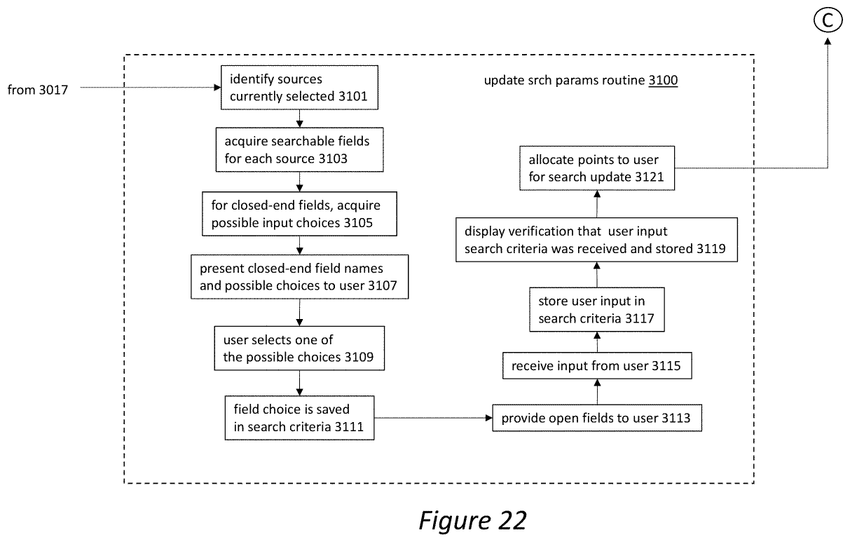

FIG. 22 shows a more detailed representation of the major steps of the ‘update search parameters’ routine 3100 which is loaded from memory 2510 and executed by UCD controller 2530 of UCD 2500. This UCD controller 2530 is connected to I/O device 2570 that interactively receives user input from RU 1 and provides output to RU 1 to review, change, update, delete search criteria.

In step 3101 RU 1 communicates through UCD 2500 to server controller 2100 of server 2000 to identify Vendor Devices 1010, Retailer Devices 1020 and Brand Devices 1030 and Registered User Devices 1110 (collectively, the “Item Sources”) with which the RU 1 would like to communicate.

In step 3103, server controller 2100 requests, receives and stores in memory 2200 the potential fields of the Item Sources which can be searched.

In step 3105, for those fields which have a limited number of pre-defined choices, (the “Closed-end Fields”) the choices are obtained from each Item Source.

In step 3107, server controller 2100 provides this information to UCD controller 2530 which presents the Closed-end Fields and possible choices for each on I/O device 2570 to RU 1. These may be presented as a pull-down menu.

In step 3109, RU 1 selects desired choices for the Closed-end Fields.

In step 3111, the choices are saved in search criteria by server controller 2100 in memory 2200.

In step 3113, fields other than Closed-end Fields are presented through I/O device 2570 to RU 1.

In step 3115, RU 1 provides input to these fields to be searched.

In step 3117, this information is also stored in memory 2200.

It should be noted that both the Closed-end Fields and other fields can be displayed together for the RU 1 to provide and update search criteria.

In step 3119, UCD controller 2530 displays a message to I/O device 2570 of the updated search fields which have been received and stored.

In step 3121, optionally, a predetermined amount of points can be allocated to the user for performing a search which server controller 2100 stores for this Registered User in memory 2200. These points may be used later as credits for free giveaways, reduced prices, or other rewards of value. Please note that the amount of points awarded for this action can be different from those awarded for other actions, such as sharing an outfit with another Registered User.

+++++++++++++++++++++++++++++++++++++++++++++

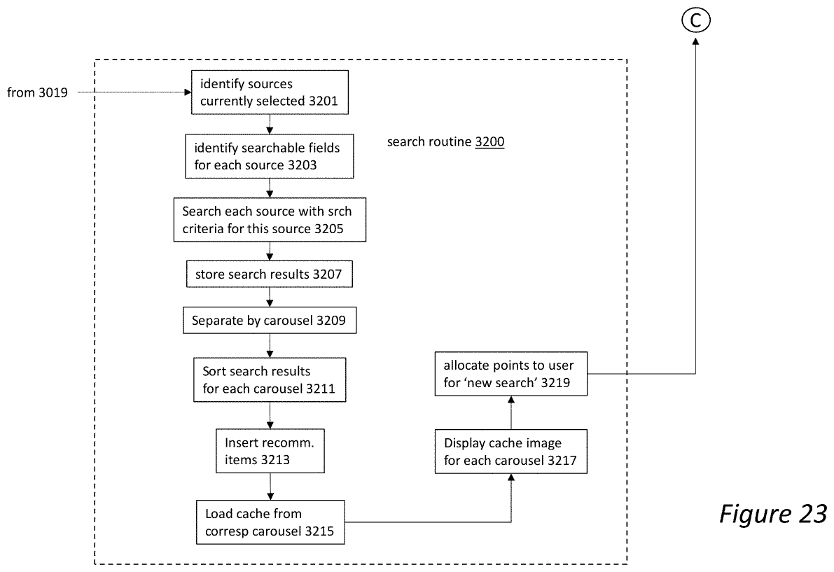

FIG. 23 shows a more detailed representation of the major steps of the ‘search’ routine 3200 which is loaded from memory 2510 and executed by UCD controller 2530 of UCD 2500.

In step 3201, the different Item Sources to search are identified by loading them from server controller 2100 loading them from memory 2200. These have been previously stored in memory 2200.

In step 3203, the different fields to be searched of the Item Sources that have previously been identified and stored in memory 2200 are also loaded.

The RU 1 may then identify the values of at least a few fields to search by interacting with search screen 6100 of FIG. 10. In this embodiment, the RU 1 may select the person type in 6101 indicate if it is for a woman, man, boy, girl, or baby. Next the RU 1 selects a style of interest 6111, 6113 for women's or men's items such as casual wear, sportswear, evening wear, street wear, formal wear, and so on that reflect time of day, activity, and lifestyle. Then the season is selected in 6121, 6123, 6115, 6117 or 6119. The inputs received from RU 1 are then converted to values of the various fields (“Search Criteria”) and sent to a server 2000 which interfaces with various Item Sources, being at least one of the Vendor devices 1010, Retailer devices 1020, and Brand Devices 1030 which are UCDs that are capable of receiving input and searching databases for items matching the Search Criteria. The plurality of matching items from all selected Item Sources are referred to as the “Search Results”.

In step 3205, of FIG. 20, the searchable fields of at least one Item Source are searched by a database extractor (Db “Extractor”) 2110 with the search criteria identified by the RU 1 in the ‘update search parameters’ routine 3100 to receive back search results.

In step 3207, Database extractor 2110 stores the search results in memory 2200.

In step 3209, a sorter 2150 determines in which carousel each of the items returned from the search results belongs. This may be by a table lookup which indicates that when three stacked carousels are used, shirts, tops, blouses, jackets and any other items typically worn by a user on their upper torso are marked as being associated with the carousel 5101 of FIG. 1, being the top carousel.

Similarly, any items worn by a user on the user's lower torso, and/or legs will be associated with carousel 5103 of FIG. 1, being the middle carousel in FIG. 1.

Also, anything worn by the user on or near their feet, would be associated with carousel 5105 of FIG. 1.

These may be calculated by the sorter 2150, or optionally be part of the database and search results. For example, it may indicate in the Item Record that in a 3-carousel system, this item is associated with the lowest carousel.

In step 3211, sorter 2150 sorts the search results into an order which places items which most closely match the preferences of RU 1. For example, a preference device 2160 in controller 210 monitors the search requests from each Registered User Device 1110, monitors which items are viewed the most, which items are viewed the longest, which items are shared the most with other Registered User Devices 1110, which are shared the most with Social media, which items have been purchased, which items have been rented in, etc. These actions may be weighted to determine preferences for each registered user. For example, buying an item might be 10 times the value of viewing it a single time. These weighted actions may then be stored and processed to determine preferences of a Registered User above what is average for a registered User. The preference information is stored in memory 2200 as user history 2201. Based upon the accumulated preferences, sorter 2150 sorts the search results such that those items with a higher preference rating will be shown first to the user whereas those with lower preference ratings will be shown later. The search results are then sorted according to preference rating at least in one embodiment.

Optionally, in step 3213, Vendor devices 1010, Retailers devices 1020, and/or Brand Devices 1030 may interact with recommendation device 2120 of server 2000 to pay for advertising of one or more of their items. The images of these items and the associated information are provided to the recommendation device 2120 which inserts the image in the proper carousel cache 2300 so that it is viewed by Registered users on I/O device 2570. By paying more, the image of the item may be inserted more than one time.

In step 3215, sorter device 2150 receives recommended items from recommendation device 2120 and merges the recommended items into the sorted search results and stores them in the appropriate carousel cache 2300 for viewing on UCD 2500.

In step 3217, an initial starting point is selected in the carousel caches 2300 and images are passed to UCD 2500 through communication device 2401 to be displayed on I/O device 2570 shown in FIG. 1.

In step 3219, a predetermined number of points are allocated to the registered user for running the ‘search’ routine 3200 and stored in the registered user's storage area in memory 2200.

+++++++++++++++++++++++++++++++++++++++++++++

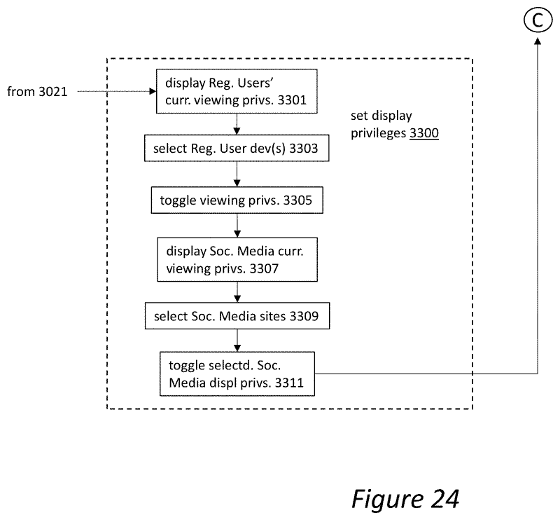

FIG. 24 shows a more detailed representation of the major steps of the ‘search’ routine 3300 which is loaded from memory 2510 and executed by UCD controller 2530 of UCD 2500.

UCD controller 2530 communicates with server 2000 through communication device 2520 to request that server controller 2100 find display privileges of each Registered User stored in memory 2200 and provide back through communication device 2401 to UCD 2500 to display the viewing privileges of each RU 1110 to I/O device 2570 of FIG. 19. The viewing privileges indicate which Registered user's devices 1110 can display the stacked carousels shown on UCD 2500.

In step 3305, the RU 1 can Interact with the I/O device 2570 to set or toggle the viewing privileges of any of the registered users 1110. Toggling switches the viewing privileges to its opposite setting. If the viewing privileges currently are on for a Registered Users device, toggling it will turn viewing privileges off.

Any other conventional means may be used to toggle, set or unset viewing privileges. The conventional means can be a representation, have a button on a touch sensitive screen, which changes its appearance when touched. Other conventional means may also be used for turning viewing privileges on or off.

In step 3307, the same process is followed to display different Social Media Sites 1150.

In step 3309, the viewing privileges for previously selected Social Media Sites 1150 are displayed to the Registered user.

In step 3309, Social Media sites 1150 are selected by the Registered user to set, unset or toggle the viewing privileges for each Social Media Site 1150 selected.

In step 3311 the state of the display privileges is provided to server controller 2100 and stored in memory 2200 for each registered user.

In an alternative environment, during setup, the Registered User can interact with the system to define which Social Media Sites will be used.

+++++++++++++++++++++++++++++++++++++++++++++

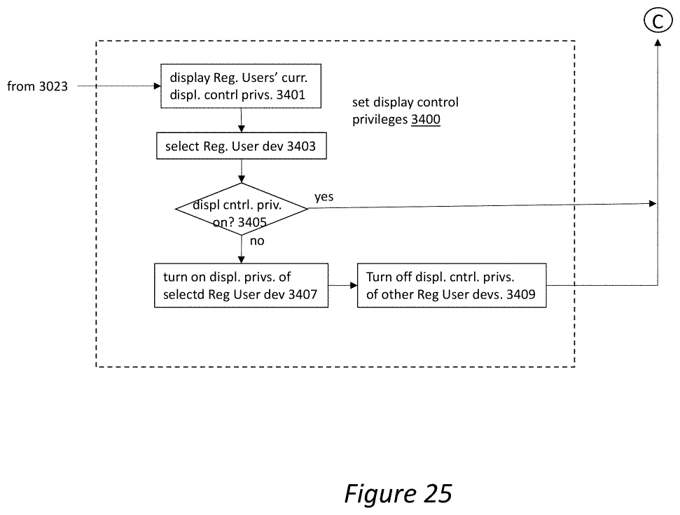

FIG. 25 shows a more detailed representation of the major steps of the ‘set display control privileges’ routine 3400 which is loaded from memory 2510 and executed by UCD controller 2530 of UCD 2500.

In step 3401, UCD controller 2530 communicates with server 2000 through communication device 2520 to request that server controller 2100 find display control privileges of each Registered User stored in memory 2200 and provide the information back through communication device 2401 to UCD 2500 to display the viewing privileges of each RU 1110 to I/O device 2570 of FIG. 19. The viewing control privileges indicate which Registered user's devices 1110 can change the display of the stacked carousels shown on UCD 2500, and Registered User Device 1100 having display control privileges set to “on”.

In step 3403, the RU 1 can interact with the I/O device 2570 to select a Registered User Device 1100.

In step 3405, it is determined if a display control variable indicating that the selected Registered User can control at least a portion of the display of UCD 2500 is set for the selected Registered User device 1110.

If it is set (“yes”), then processing continues at step 3029 of FIG. 20.

If it is not set (“no”), then the variable for the display privileges for the selected Registered User device 1110 is turned on in step 3407.

Variables for display control privileges are then turned off for all other Registered Users 1110 in step 3409.

+++++++++++++++++++++++++++++++++++++++++++++

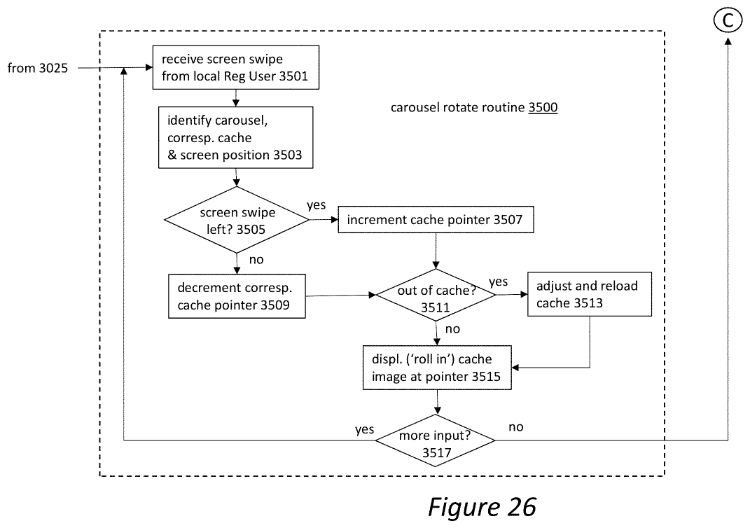

FIG. 26 shows a more detailed representation of the major steps of the ‘carousel rotate’ routine 3500 which is loaded from memory 2510 and executed by UCD controller 2530 of UCD 2500.

In step 3501, UCD controller 2530 monitors input/output device 2570 to determine if registered user has swiped the screen of one of the displayed carousels.

In step 3503, UCD controller 2530 identifies the carousel swiped, the cache corresponding to the carousel, and a location of a pointer within the carousel cache.

In step 3505, it is determined if the swipe of the carousel is to the left.

If the swipe is to the left (“yes”), then the cache pointer is incremented in step 3507 to an image of the next item.

If the swipe is to the right (“no”) in step 3505, then the cache pointer is decremented in step 3509 to an image of a previous item.

In step 3511 it is determined if the cache pointer is out of bounds of the cache. If not (“no”) then, in step 3515 the image relating to the cache pointer is rotated into view of that carousel imitating rotation of a mechanical carousel rotating from left to right and out of the screen view for a left to right swipe of the of I/O device 2570, or right to left and out of the screen view for a right to left swipe on the output device 2570.

If the cache pointer is out of the bounds of the cache (“yes”), the caching device 2140 reloads the cache. For example, if the point exceeded the highest cache location (ran over the top′), then caching device 2140 moves the items and images in an upper portion of the cache and writes them over the lower portion of the cache. It then loads new images and items in the upper portion which was just moved.

A similar function happens when the cache pointer is less than the lowest memory location for the cache. In this case, a lower portion of the images and items is picked up and written over the upper portion. Caching device 2140 then loads new items and images from cloud storage 1130 and writes them over the locations at the lower end of the cache with items/images taken from the cloud storage 1130.

In step 3517 it is determined if there is any more input being received from the Registered User. If so (“yes”), processing continues back at step 3501.

If there is not additional input to be processed (‘no”), then processing returns to step 3029 of FIG. 20.

+++++++++++++++++++++++++++++++++++++++++++++

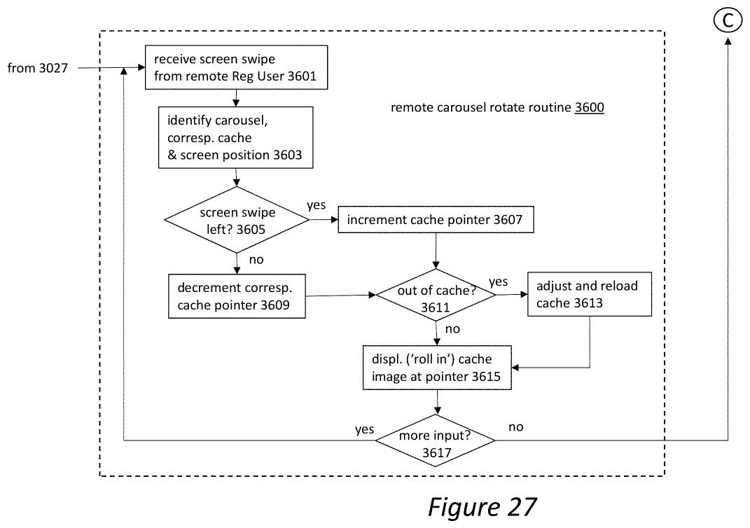

FIG. 27 shows a more detailed representation of the major steps of the ‘remote carousel rotate’ routine 3600 which is loaded from memory 2510 and executed by UCD controller 2530 of UCD 2500.

Steps 3601 through 3617 are the same as steps 3510 through 3517 of FIG. 26 with the exception that the control of the display and carousels is by a remote Registered User operating one of the Registered User Devices 1110 instead of RU 1 operating UCD 2500 which was granted display control privileges in ‘set display control privileges’ routine 3400 of FIG. 25. The Registered User device granting remote control of its display will always have the ability to retract control at any time.

+++++++++++++++++++++++++++++++++++++++++++++

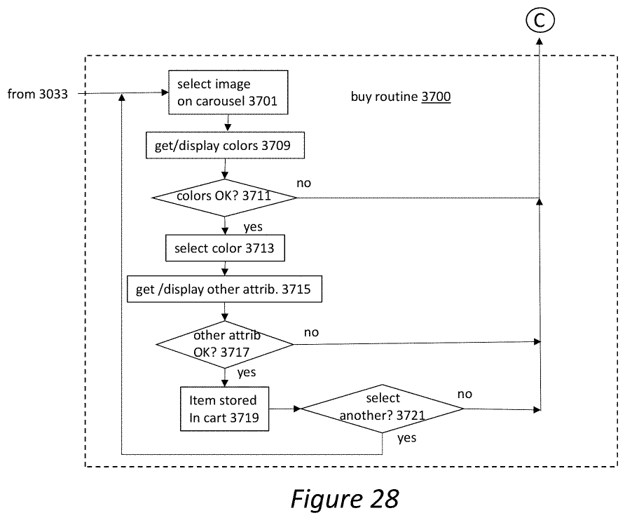

FIG. 28 shows a more detailed representation of the major steps of the ‘buy’ routine 3700 which is loaded from memory 2510 and executed by UCD controller 2530 of UCD 2500.

In step 3701, after setting search criteria, receiving search results and interactively displaying items/images on the rotating carousels, the Registered User may select an image/item on at least one of the carousels through the I/O device 2570.

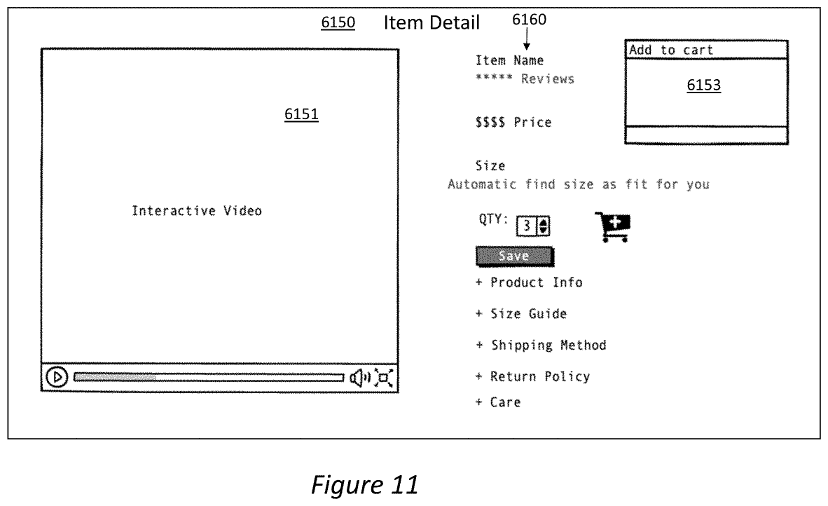

The RU 1 may then select further information on the item, such as by double clicking in the items shown on one of the carousels, or by selecting the item and clicking on a button indicating more item information. This will bring up another screen such as item detail screen 6150 of FIG. 11.

In this embodiment, there is a video field 6151 which will play prestored videos advertising the item or information related to the item. There are also other fields which populate with information on the item, such as name, price, size, quantity in stock, shipping method, etc. (These can vary in alternative embodiments.) There is also a button which allows the user to save the item to review later.

In step 3709, RU 1 interacts with UCD 2500 to send a request to database extractor 2110 to acquire available color information for the items in the cart from the cloud storage 1130. The received colors are displayed on UCD 2500 to the RU 1.

In step 3711, it is determined if at least one available color is acceptable.

If not (“no”), then processing continues at step 3029 of FIG. 20. If so, (“yes”), then the RU 1 selects a color in step 3713.

In step 3715, RU 1 interacts with UCD 2500 to send a request to database extractor 2110 to acquire availability of another attribute for the items in the cart from the cloud storage 1130. The received available attribute information is displayed on UCD 2500 to the RU 1.

In step 3717, it is determined if one of the available choices for the other attribute is acceptable. If not (‘no”) then processing continues at step 3029 of FIG. 20.

If so (“yes”), then in step 3719, the image and information for this item is stored in a ‘cart’ being an area allocated for items chosen by this Registered user to buy or rent-in located in memory 2200 of server 2000.

In step 3721 it is determined if there is another item to buy. If not (“no”), then processing continues at step 3029 of FIG. 20.

If so, (“yes”), then processing continues at step 3701 of this Figure to repeat these steps for the next item.

+++++++++++++++++++++++++++++++++++++++++++++

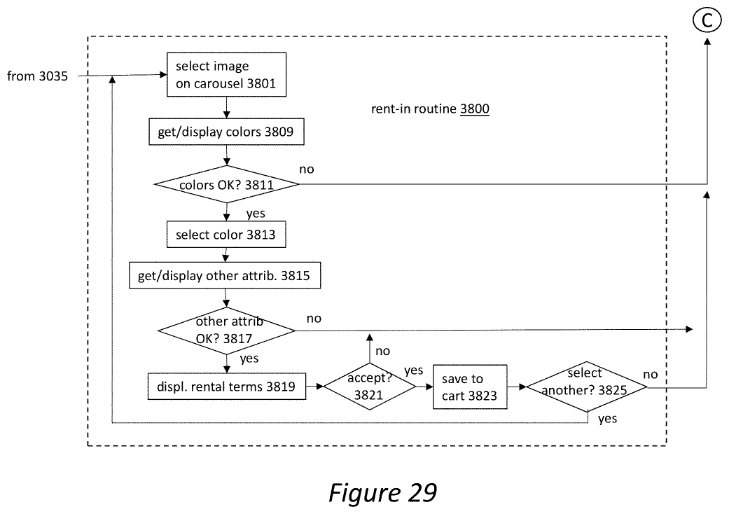

FIG. 29 is a more detailed illustration of the steps to perform the ‘rent-in’ routine 3800 of FIG. 21.

In step 3801, after setting search criteria, receiving search results and interactively displaying items/images on the rotating carousels, the Registered User may select an image/item on at least one of the carousels through the I/O device 2570.

In step 3809, RU 1 interacts with UCD 2500 to send a request to database extractor 2110 to acquire available color information for the items in the cart from the cloud storage 1130. The received colors are displayed on UCD 2500 to the RU 1.

In step 3811, it is determined if at least one available color is acceptable.

If not (“no”), then processing continues at step 3029 of FIG. 20. If so, (“yes”), then the RU 1 selects a color in step 3813.

In step 3815, RU 1 interacts with UCD 2500 to send a request to database extractor 2110 to acquire availability of another attribute for the items in the cart from the cloud storage 1130. The received available attribute information is displayed on UCD 2500 to the RU 1.

In step 3817, it is determined if one of the available choices for the other attribute is acceptable. If not (‘no”) then processing continues at step 3029 of FIG. 20.

In step 3819 the rental terms are displayed to the potential renter.

In step 3821 it is determined if the rental terms are acceptable. If not (“no”), then processing continues at step 3029 of FIG. 20.

If so, (“yes”), then the item is saved to the cart in step 3823.

In step 3825 it is determined if there is another item to be rented in. If not (“no”), then processing continues at step 3029 of FIG. 20.

If so, (“yes”), then processing continues at step 3801 of this Figure to repeat these steps for the next item.

+++++++++++++++++++++++++++++++++++++++++++++

FIG. 30 is a more detailed illustration of the steps to perform the ‘sell’ routine 3900 of FIG. 21.

The routine starts at step 3901 in which RU 1 at UCD 2500 receives a request to purchase an item RU 1 has in his/her closet 2501 that was previously imaged, described and uploaded from closet 2501, that was advertised as being for sale to other Registered User Devices 1110.

In step 3903, UCD 2500 then searches memory 2200 having prestored images and item information relating to closet 2501 which match the requested item number, to determine if it is still available for sale in step 3905.

If not (“no”), then in step 3911 a message indicating that the item is no longer available is displayed on the display screen of the Registered user device 1110 which requested the item.

If so (“yes”), then the item should be packaged in step 3907.

Then in step 3909, the item should be mailed or shipped to the buyer.

Processing them returns to step 3029 of FIG. 20.

+++++++++++++++++++++++++++++++++++++++++++++

FIG. 31 is a more detailed illustration of the steps to perform the rent-out routine 4100 of FIG. 21.

The routine starts at step 4101 in which RU 1 at UCD 2500 receives a request to rent-out an item RU 1 has in his/her closet 2501 that was previously imaged, described and uploaded from closet 2501 to rent-out, that was advertised to other Registered User Devices 1110.

UCD 2500 then checks memory 2200 of server 2000 to find a record having images and description which match the requested item number and to determine if it is still available for sale in step 4105.

If not (“no”), then in step 4115 a message indicating that the item is no longer available is displayed on the display screen of the Registered user device 1110 which requested the item.

If so (“yes”), then UCD 2500 displays the terms of the rental to the requesting Registered user in step 4107.

In step 4109, it is determined if the Requesting user accepts the rental terms. If not (“no”), then processing continues at step 3029 of FIG. 20.

If so (“yes”), then the item is packaged in step 4111.

In step 4113 the packaged item is then shipped or mail to the renter.

Processing then returns to step 3029 of FIG. 20.

+++++++++++++++++++++++++++++++++++++++++++++

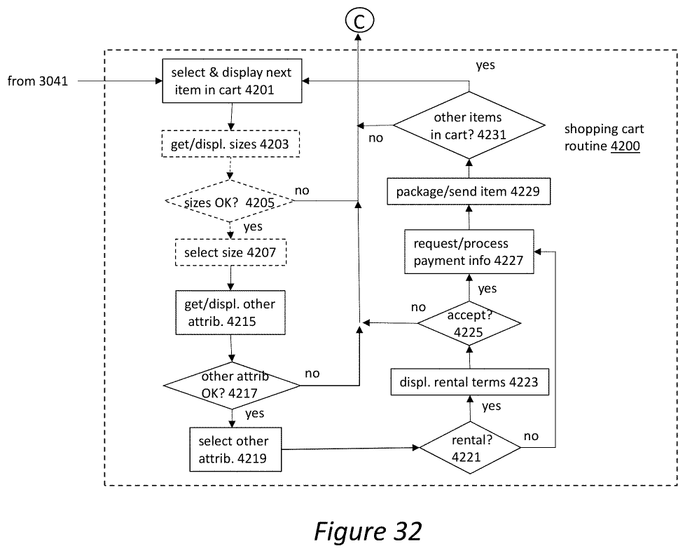

FIG. 32 is a more detailed illustration of the steps to perform the ‘shopping cart’ routine 4200 of FIG. 21.

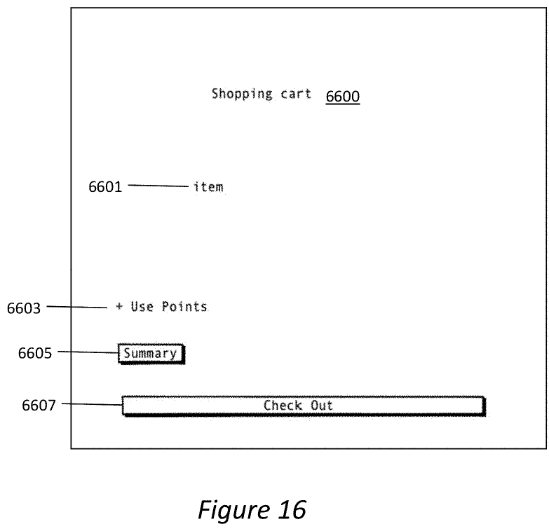

In step 4201, the shopping cart screen 6600 of FIG. 16 is displayed to the RU 1. It includes a listing of the items in field 6601, a button “+Use Points” which includes further instructions and selectable fields to apply accumulated points toward a purchase.

There is also a “Summary” button which causes a summary of the items currently stored in the shopping cart, and a “Check Out” button 6607 which allows RU 1 to complete purchases or rentals.

Now referring back to FIG. 19, UCD controller 2530 communicates through communication device 2520 to cause server controller 2100 of server 2000 to select images and information relating to an item in the cart section for RU 1 in memory 2200. The images and information are passed back to UCD 2500 to display on I/O device 2570 to RU 1.

If the available item sizes are not displayed and selected in the ‘buy’ routine 3700 shown in FIG. 28 or ‘rent-in’ routine 3800, shown in FIG. 29, these steps are then executed in the ‘shopping cart’ routine 4200 of FIG. 32.

In step 4203, database extractor 2110 sends a request to one of the Item Sources having the item for sale and requests the sizes currently available for this item and displays them to RU 1 on the I/O device 2570.

In step 4205, the RU 1 indicates if the sizes are acceptable. If not (“no”), then processing continues at 3029 of FIG. 20.

If so (“yes”), then a size is selected in step 4207 through I/O device 2570 in FIG. 19. This may be done by displaying on I/O device 2570 of UCD 2500 a screen such as that shown in FIG. 8 and receiving user input from the RU 1 and receiving input through Actuation Devices on the I/O device 2570.

In step 4215, values of other searchable attributes of the selected item may be chosen, extracted from the Item Source offering the item, then displayed on the I/O device 2570.

In step 4217, the RU 1 then indicates if the values for the attribute of the item are acceptable. If not (“no”) then processing continues at step 3029 of FIG. 20.

If so (“yes”), then the RU 1 selects one of the available values of the attributes in step 4219.

All selections of the RU 1 are stored in the cart section of memory.

In step 4221, it is determined if the RU 1 wants to rent the item (as opposed to buying the item).

If so (“yes”), then the rental terms are displayed to the potential renter on a display device on the Registered user device 1110 of FIG. 17 of the potential renter with a button to accept the terms and a button to cancel (and not accept the rental terms).

In step 4225, if the potential renter accepts the rental terms (“yes”), then in step 4227 RU 1 through UCD 2500 requests, receives and processes payment information.

In step 4229, the item is packaged and either shipped or mailed to the buyer/renter.

This item, its image and related information are all stored in a section of memory 2200 referred to as the ‘cart’. This mimics a shopping cart which holds items the Registered User plans to purchase or rent.

In step 4231, it is determined if there are other items in the cart which have not been processed. If so (“yes”), then processing continues at step 4201.

If not (“no”), then processing continues at step 3029 of FIG. 20.

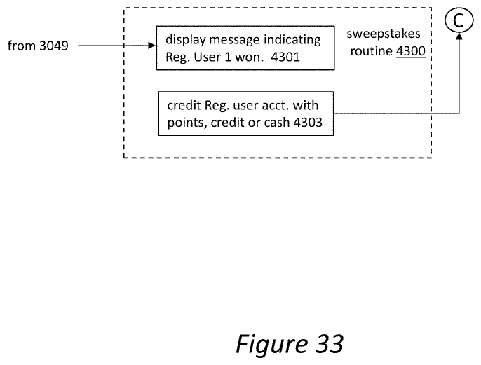

FIG. 33 is a more detailed illustration of the steps to perform the ‘sweepstakes’ routine 4300 of FIG. 21.

Step 4301 is only executed if the sweepstakes counter which was preset with a random number has decremented to 0 in step 3049 for the current user, RU 1. A message is displayed on UCD 2500 indicating that RU 1 has won the sweepstakes.

In step 4303, server controller 2100 of server 2000 updates a memory space set aside for the points, credits or cash currently accumulated by RU 1, adding a predetermined sweepstakes amount.

Processing then continues at step 3029 of FIG. 20.

Even though certain functions are described as being performed by the described elements, it is to be understood that this is for illustration purposes only. It is within the spirit of the invention to have some of the functions performed by other elements of the system. For example, a function performed by the User's Computing Device 2500 can be done by the server 2000, or vice versa with the appropriate adjustments.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant reserves the right to physically incorporate into the written description or any other portion of the application, any and all such claims. Thus, for example, under no circumstances may the patent be interpreted as allegedly not providing a written description for a claim on the assertion that the precise wording of the claim is not set forth in the written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Therefore, provided herein is a novel system. The novel system, according to various embodiments of the present invention, offers the following advantages: ease of use; lightness in weight; durability; excellent tool retaining characteristics; and the ability to retain tools having different handle sizes. In fact, in many of the preferred embodiments, these advantages of ease of use, are optimized to an extent that is considerably higher than heretofore achieved in prior, known systems.

We claim:

1. An e-commerce system for buying items online which is entertaining to use, comprising:
a. a plurality of remotely connected Item Sources, the Item Sources including databases of prestored Item Records, and are adapted to return search results when provided with search criteria;
b. a server adapted to remotely communicate with the Item Sources to receive user input, create search criteria from the user input, send search criteria to the Item Sources, receive search results from the Item Sources, separate the search results into a plurality of display levels; and provide specified Item Records when requested and a plurality of carousel caches, each adapted to store a plurality of Item Records for a corresponding carousel display level;
c. a cloud storage coupled to the server for receiving information from the server, storing it and providing information back to the server;
d. a user computing device (UCD) comprising:
i. a display device for displaying a stacked carousel display having a carousel display for each of a plurality of levels, each carousel displaying an item image of an Item Record;
ii. an input device that receives user input to select a specific carousel display on a specific level and request that carousel display level and a specific rotation direction;
iii. a controller coupled to the input device, the display device and the server through a communication device, that receives the user input and sends a next Item Record in a carousel cache for the specific carousel display level to be sent to the display device when the user input indicates a rotation in a first direction and sends a previous Item Record to be displayed on the specified carousel display level of the display device when the user input indicates a rotation in a second direction, thereby simulating rotation of an image carousel; wherein the user, through the input device, can select an item corresponding to an image displayed on a carousel display level, and send information to purchase the item online.

2. The e-commerce system of claim 1, wherein the Item Sources include at least one Vendor Device, Retailer Device, Brand Device or Registered User Device.

3. The e-commerce system of claim 1, wherein the search results comprise:
plurality of Item Records, each Item Record comprising images of items and item information.

4. The e-commerce system of claim 3 which may further comprise:
videos of items.

5. The e-commerce system of claim 1, wherein the items are offered for one of sale and rental.

6. The e-commerce system of claim 1, wherein the controller comprises:
a recommendation device which inserts item records recommended by an Item Source into the search results.

7. The e-commerce system of claim 1, wherein the controller comprises:
a. a preference device which monitors, analyzes and stores search criteria and time of review of items to determine a user's preferences; and
b. a sorter which sorts search results for each user based upon the user's preferences.

8. The e-commerce system of claim 1 further comprising:
a. one of Social Media Sites and registered users remotely coupled to the server;
b. wherein the input device is further adapted to receive user input indicating which Social Media Sites and registered users are authorized to view the user's display device;
c. the controller of the UCD is further adapted to send images on the display device to the server; and
d. the server is adapted to provide the images displayed on the display device to the Social Media Sites and Registered Users which user input has authorized to view the display.

9. The e-commerce system of claim 8 wherein:
a. the input device is further adapted to receive user input indicating which one of the Social Media Sites and Registered Users is authorized to control carousel rotation of the user's display device;
b. the controller of the server is further adapted to receive carousel rotation commands from the entity authorized to control the carousel rotation and forward the carousel rotation commands to the UCD; and
c. the UCD is further adapted to implement the carousel rotation command from the authorized entity.

10. The system of claim 1, further wherein the input device comprises:
one of a touch-sensitive screen, a conventional mouse and a voice recognition device.

11. The system of claim 1, further wherein the display device comprises:
one of a touch-sensitive screen and a conventional computer display screen.

12. An entertaining e-commerce system comprising:
a. a plurality of Item Sources each having prestored information and images on a plurality of items in the form of Item Records;
wherein the Item Sources are adapted to receive search criteria and provide search results in the form of Item Records;
b. a server coupled to the Item Sources through a network, adapted to:
i. receive search criteria,
ii. provide the search criteria to at least one Item Source;
iii. receive the search results, being a plurality of Item Records from the at least one Item Source;
iv. sort the Item Records by their carousel display levels corresponding to a location on a user's body where the item will be worn;
v. store the Item Records into a carousel cache corresponding to the carousel display level associated with each;
c. user's computing device (UCD) comprising;
i. an output device capable of displaying at least one stacked carousel having a plurality of carousel display levels vertically stacked upon each other, each with each vertical level pertaining to a section of a standing mannequin,
wherein each carousel display level displays images of items that are rotatable to the left and right, simulating a physical carousel;
ii. an input device for receiving user input specifying a carousel level and a direction in which to spin the carousel display level, and
for receiving user input identifying values of fields displayed on the output device for the user to view;
iii. a UDC controller coupled to the input and output devices, adapted to:
1. receive user input indicating a carousel display level to be rotated and the direction to rotate;
2. acquiring a next image record from the current Item Record being displayed from the carousel cache associated with the indicated carousel display, if the rotation direction is to the right of the output device; and acquiring a previous Item Record relative to the current Item Record when the indicated rotation is to the left of the output device and cause the output device to display an image from the acquired image record, thereby simulating rotation of a carousel.

13. The e-commerce system of claim 12, wherein the Item Sources include at least one of the group consisting of: Vendor Devices, Retailer Devices, Brand Devices or Registered User Devices.

14. The e-commerce system of claim 12, wherein the search results comprise:
a plurality of Item Records, each Item Record comprising images of items and item information.

15. The e-commerce system of claim 14 which may further comprise:
videos of items.

16. The system of claim 12, further wherein the input device comprises:
one of a touch-sensitive screen, a conventional mouse and a voice recognition device.

17. The system of claim 12, further wherein the output device comprises:
one of a touch-sensitive screen and a conventional computer display screen.

18. A method of e-commerce for items comprising the steps of:
a. employing a server controller to load a previously stored state of the system from a memory in the server controller;
b. providing displays of images of items on a plurality of carousel displays, each at a different level of a stacked carousel display on an output device to a Register User 1 (“RU 1”);
c. employing an input device to interactively receive user input from RU 1 rotating at least one carousel display level in one of a left direction and a right direction;
d. displaying on the output device a next image, relative to a currently displayed image, that was prestored in a carousel cache, when the user input indicates a rotation of an image on the carousel display level to a left of the output device;
e. displaying on the output device a previous image, relative to a currently displayed image, that was prestored in a carousel cache. when the user input indicates a rotation of an image on a carousel display level to the right of the output device;
f. displaying to a connected Registered User at least one combination of items (an outfit) displayed on the carousel display levels of at least one Registered User Device, when indicated by user input;
g. receiving user input from the UCD allowing another connected Registered Users to view the current images on the carousel display levels of the UCD, when indicated by user input;
h. employing the UCD and a server to perform an item search on at least one Item Source to result in a plurality of item records, some of which are stored by the server in the carousel caches;
i. actuating the input device of the UCD to rotating the item so that it is displayed on one of the carousel display levels;
j. employing the input device of the UCD to select a displayed item;
k. acquiring the selected item by one of purchasing, renting-in, or swapping another item for the selected item.

19. The method of e-commerce of claim 18 wherein the step of performing an item search comprises the steps of:
a. receiving user input;
b. using the user input to create search criteria,
c. sending the search criteria to at least one Item Source having a plurality of prestored Item Records;
d. receiving the search results, being a subset of the prestored Item Records,
e. sorting the search results;
f. separating the search results into carousel display levels pertaining to where the item is worn on a person's body; and
g. loading images in a plurality of carousel caches that each correspond to a specific carousel display level;
h. displaying images at carousel display levels that are from a corresponding carousel cache.

20. The method of e-commerce of claim 18 wherein the Item Sources searched are at least one of Vendor Devices, Retailer Devices, Brand Devices and Registered User Devices.
